(19) United States
(12) Patent Application Publication
(10) Pub. No.: US 2016/0054909 A1
(43) Pub. Date: Feb. 25, 2016

(54) ENGINEERING DEVICE AND SCREEN DISPLAY CONTROLLING METHOD

(71) Applicant: AZBIL CORPORATION, Tokyo (JP)

(72) Inventor: Takayoshi KOYANAGI, Tokyo (JP)

(73) Assignee: AZBIL CORPORATION, Tokyo (JP)

(21) Appl. No.: 14/831,435

(22) Filed: Aug. 20, 2015

(30) Foreign Application Priority Data
Aug. 22, 2014 (JP) 2014-169591

(51) Int. Cl. G06F 3/0484; G06F 3/0482

(52) U.S. Cl. CPC G06F 3/04847; G06F 3/0482

(57) ABSTRACT

An engineering device including a menu selector selecting an operating menu; a program group display controller displaying, on a display screen, screens relating to each of one or more programs, grouped in advance as a program group relating to the operating menu selected by the menu selector; a program launcher activating a program other than the engineering tool and displaying, on the front-most screen of the display screen, a screen relating to the other program that has been activated; a screen switch switching the display of the display screen so as to move, to the front-most screen of the display screen, screens relating to the individual programs that have been set as the program group, when there has been a screen switching request; and a screen display controller adjusting the size or position of respective windows for each of the screens in response to a display position adjusting instruction.

### CROSS-REFERENCE TO RELATED APPLICATION

This application claims priority under 35 U.S.C. §119 to Japanese Patent Application No. 2014-169591, filed on Aug. 22, 2014, the entire content of which is being hereby incorporated herein by reference.

### FIELD OF TECHNOLOGY

This invention relates to an engineering device that carries out display control for a screen, and a screen display controlling method.

### BACKGROUND

Conventionally, on work floors wherein production processes are controlled, and in systems for monitoring and controlling building facilities, various types of devices with various types of communication functions, for example, sensors, valves, pumps, and the like, are installed.

These devices have parameters and values set by an engineering device depending on the details of the production process and depending on control of instruments. The operations for setting parameters, and the like, are carried out following the sequence (timing) for the operating processes and control, but there are dependency relationships between the data that are generated in the setup operations. Because of this, for these setup operations, a plurality of screens is prepared, for separate purposes, where screens are displayed from menus to launch simultaneously general-use spreadsheet programs, and the like, where operations are carried out while switching between these many screens (menus). Moreover, even when carrying out operations for confirming the details of the setups, these are carried out sequentially while switching between these multiple screens. See, for example, Japanese Unexamined Patent Application Publication 2013-182309 (the “JP '309”).

However, in the conventional technology, as disclosed in JP '309, a large number of screens are displayed from a menu screen, and because the setup operations are carried out repetitively, there are problems in that this is extremely time-consuming, and efficiency is poor. Moreover, the operator must perform operations in order to activate the screen for which the setup operation is to be performed, by bringing that screen to the front, and there is a problem in that the operations to do so must be carried out repetitively.

The present invention was created in order to solve issues such as described above, and the object thereof is provide an engineering device and a screen display controlling method, for carrying out the control of display of screen groups for carrying out operations, and of other screens, hierarchically, to reduce the number of screen switching operations, to enable operations to be performed efficiently.

### SUMMARY

An engineering device according to the present invention is an engineering device for defining control points for monitoring and controlling equipment that is installed in a building, and for defining parameters for carrying out control of instruments, including a menu selecting portion that selects an operating menu from operating menu items of an engineering tool, prepared in advance; a program group display controlling portion that displays, on a display screen, screens relating to each of one or more programs, grouped in advance as a program group relating to the operating menu selected by the menu selecting portion; a program launching portion that activates a program other than the engineering tool and that displays, on the front-most screen of the display screen, a screen relating to the other program that has been activated; a screen switching portion that switches the display of the display screen so as to move, to the front-most screen of the display screen, screens relating to the individual programs that have been set as the program group, when there has been a screen switching request; and a screen display controlling portion that adjusts the size or position of respective windows for a screen relating to the program group on the display screen in response to a display position adjusting instruction.

The present invention enables the control of displaying of a screen group for carrying out operations, and of other screens, to be carried out hierarchically, thereby enabling operations to be performed efficiently through reducing the number of screen switching operations.

### BRIEF DESCRIPTION OF THE DRAWINGS

FIG. 1 is a structural diagram of an engineering device according to an Example according to the present invention.

FIG. 2 is a flowchart for explaining an example of the operations in the engineering device according to the Example according to the present invention.

FIG. 3 is a diagram for explaining the state wherein the program screen is not displayed.

FIG. 4 is a diagram for explaining operation of a screen display wherein each screen related to programs of the same program group is displayed, through a program group display controlling portion.

FIG. 5 is a diagram for explaining an example wherein a display screen position adjustment is carried out through the screen display controlling portion.

FIG. 6 is a diagram for explaining an example wherein a screen of a program other than the engineering tool is displayed, as instructed by a user, through a program launching portion.

FIG. 7 is a diagram for explaining an example of an operation for restoring the state of a display through clicking on an individual screen of a program group in normal operations.

FIG. 8 is a diagram for explaining one example of a screen wherein display switching has been carried out through the screen switching portion.

FIG. 9 is a diagram for explaining an example of a screen wherein display switching has been carried out through clicking of an icon in a sheet screen that has been stored in a task tray (a notification region).

FIG. 10 is a diagram for explaining an example of a screen wherein display switching has been carried out so that a screen that has received an operation selecting portion is displayed as the front-most screen by the screen switching portion.

### DETAILED DESCRIPTION

An embodiment according to the present disclosure will be explained in detail below referencing the figures.

### Example

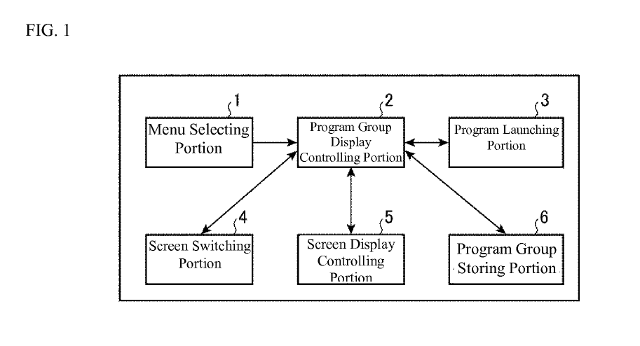

FIG. 1 is a structural diagram of an engineering device according to an Example according to the present invention.

The engineering device is a device for defining control points for monitoring/controlling equipment that is disposed in a building, and for defining parameters for carrying out control.

As illustrated in FIG. 1, the engineering device includes a menu selecting portion 1, a program group display controlling portion 2, a program launching portion 3, a screen switching portion 4, a screen display controlling portion 5, and a program group storing portion 6.

The menu selecting portion 1 selects an operating menu desired by a user, from among operating menu items displayed when an engineering tool is activated for carrying out operations such as defining various types of devices, setting parameters, and the like, in accordance with a selection instruction by a user. Note that the operating menu items of the engineering tool are prepared in advance.

The program group display controlling portion 2 displays, as a program group relating to an operating menu selected by the menu selecting portion 1, that is, as a program group that is related when an operating menu is executed, respective screens relating to at least one program, doing so on a display screen (a displaying portion, not shown in the figure). For example, device list screens, point list screens for defining what data is controlled by a device, point detail screens, graphic screen definition screens, and the like, are displayed multiply in an operating window with all of one or more programs that include dependent data as a single group.

The program launching portion 3 activates the applicable program, based on an activating instruction of a program other than the engineering tool, such as general-use spreadsheet software, or the like, to display the screen of the activated program as the front-most screen.

The screen switching portion 4 switches the displaying of the display screen when the sheet screen (where, in this Example, a “sheet screen” is a screen that overlays the desktop screen) is operated by a user, that is, when there is a switching request by the user. For example, the screen for the program other than the engineering tool, which is displayed, for example, as the front-most screen, is moved to be the back-most screen. Conversely, the program other than the engineering tool, which is displayed as the front-most screen, is made inactive, and the screen for the program groups of the engineering tool is switched to be the front-most screen, and, of that, one window screen is put into the active state.

The screen display controlling portion 5 carries out setting of window screens to active/inactive, along with adjusting the sizes and positions of the window screens, for the respective screens relating to a plurality of program groups on the display screen, in accordance with a display position adjusting instruction by an operation by a user.

The program group storing portion 6 stores related programs at the time of execution of an operating menu of engineering tools that are grouped as a program group. Note that in this Example, the program group storing portion 6 is provided by an engineering operating device, but there is no limitation thereto, and it may instead be provided outside of the engineering device.

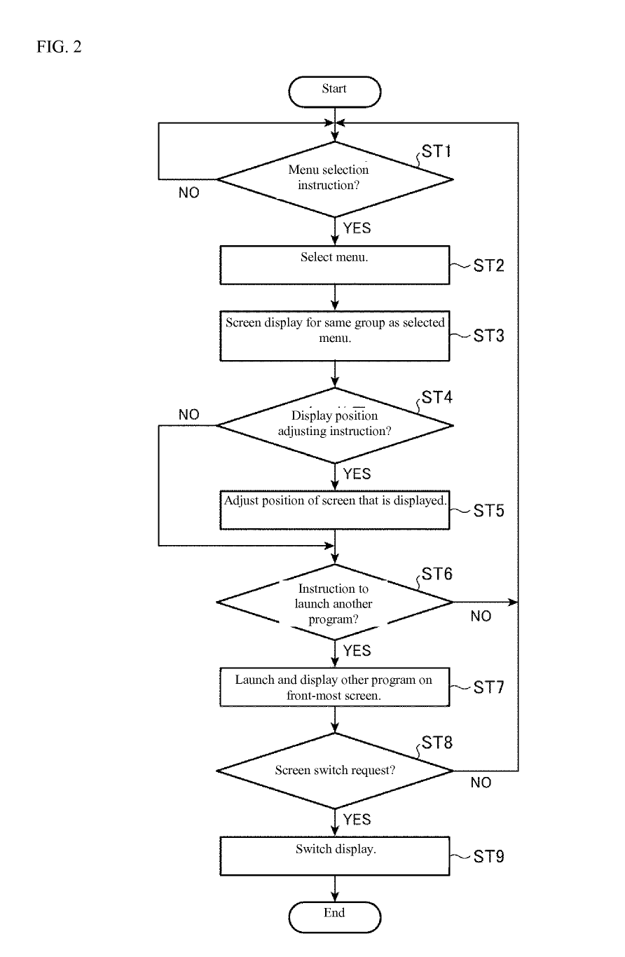

FIG. 2 is a flowchart for explaining an example of the operations in the engineering device according to the Example according to the present invention.

The menu selecting portion 1 evaluates whether or not a selection instruction by a user has been received, through an inputting portion (not shown) from a selection menu that is displayed when an engineering tool that carries out operations for defining various types of devices, setting parameters, or the like, is activated, that is, evaluates whether or not there has been a menu selecting instruction by a user (Step ST1).

If, in Step ST1, there has been no selection instruction from a user (“NO” in Step ST1), then the procedure in Step ST1 is repeated.

If, in Step ST1, there has been a selection by a user (“YES” in Step ST1), then the menu selecting portion 1 follows the selection instruction by the user to select the operating menu desired by the user (Step ST2). Note that the operating menu items of the engineering tool are prepared in advance.

The program group display controlling portion 2 displays, on a display screen (a displaying portion, not shown in the figure), a screen relating to one or more programs that have been grouped in advance as a program group, relating to the operating menu selected by the menu selecting portion 1 in Step ST2 (Step ST3). Specifically, the programs that are related when executing an operating menu of the engineering tool, which are grouped as a program group, are stored in the program group storing portion 6, and the program group display controlling portion 2 references the program group storing portion 6, to display screens relating to each individual program of the one or more programs that are grouped in advance as a program group relating to the operating menu selected by the menu selecting portion 1.

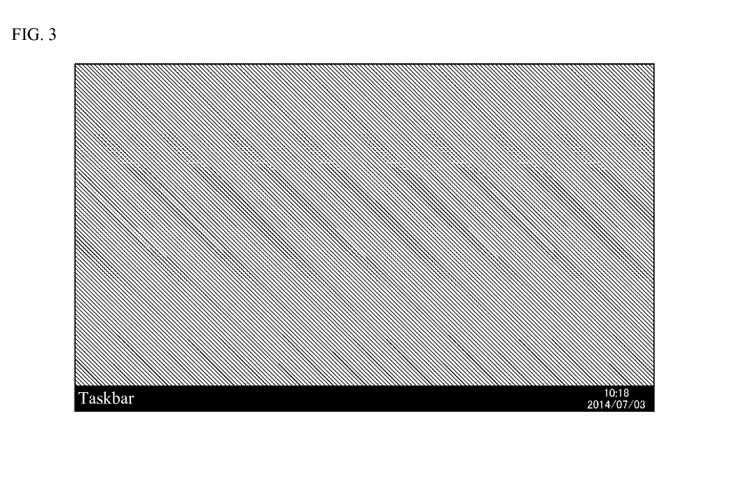

FIG. 3 is a diagram for explaining the state wherein the program screen is not displayed. For example, this is the desktop screen in Windows®.

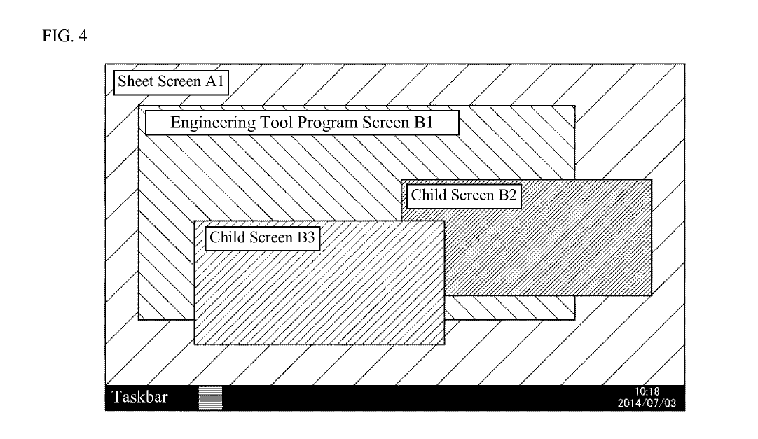

FIG. 4 is a diagram for explaining operation of a screen display wherein each screen related to programs of the same program group is displayed, through a program group display controlling portion 2.

For example, when, in the state illustrated in FIG. 3, an engineering tool B is executed, then the screen A1 that is related to the engineering tool B, and the engineering tool program screen B1, are displayed. Furthermore, a child screen B2, followed by a child screen B3 are displayed, displayed on the screen as shown in FIG. 4, through operations on the engineering tool program screen B1.

Note that in FIG. 4, the sheet screen A1 indicates the screen that overlays the desktop screen, where here the screen that overlays this desktop screen is termed a “sheet screen.” Note that the sheet screen A1 is semi-transparent, and the background desktop can be seen somewhat there through.

The program group display controlling portion 2 displays all of the screens in the program group for the engineering tool B (“program group B”), that is, the engineering tool program screen B1, the child screen B2, and the child screen B3, at a higher-level (in front of) the sheet screen A1. Here, as illustrated in FIG. 4, the display order, from the front-most screen, is the child screen B3, the child screen B2, the engineering tool program screen B1, and the sheet screen A1.

The program group B that structures the engineering tool B is set in advance and stored in the program group storing portion 6.

Note that in FIG. 4 the program group B is illustrated as an example that is structured from three programs, but this is no more than one example, and a program group for the same group in an operating menu may be structured from one or more programs.

Here the user is able to adjust the position of the display, and set to active/inactive, the screen for the program group B that is displayed on the display group.

Given this, the screen display controlling portion 5 evaluates whether or not there has been a display position adjusting instruction by the user, from the inputting portion, for the plurality of screens displayed by the program group display controlling portion 2 (Step ST4).

If, in Step ST4, there has been a display position adjusting instruction (“YES” in Step ST4), then the screen display controlling portion 5 adjusts the position of the screen that is displayed, in accordance with the display position adjusting instruction that has been received (Step ST5).

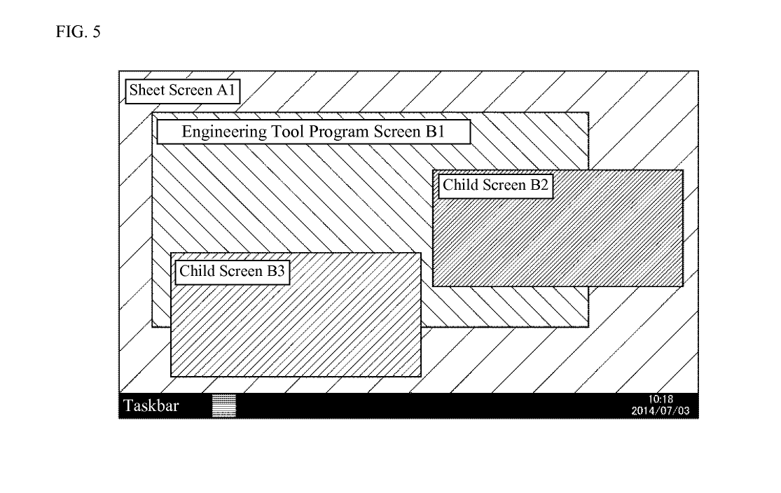

FIG. 5 is a diagram for explaining an example wherein a display screen position adjustment is carried out through the screen display controlling portion 5.

When there has been an instruction for adjusting the display position of the child screen B2 and the child screen B3 by a user, the screen display controlling portion 5 follows the instruction to adjust the screen display positions or sizes. For example, from the screen illustrated in FIG. 4, if the child screen B2 and child screen B3 are to be positioned so that the child screen B2 and the child screen B3 will not overlap, then the screen display controlling portion 5 adjusts the screens as illustrated in FIG. 5. Note that the layout in FIG. 5 is no more than one example, and the user is able to adjust the display positions for the screens as appropriate.

If, in Step ST4, there has been no display position adjusting instruction (“NO” in Step ST4), then the procedure in Step ST5 is skipped, and processing advances to Step ST6. Here it is assumed that there has been no display position adjusting instruction from the user, from the screen illustrated in FIG. 4.

The program launching portion 3 evaluates whether or not there has been an instruction for activating a program other than an engineering tool, for example, a general-use spreadsheet software, by a user through an inputting portion (not shown) (Step ST6).

If, in Step ST6, there has been no instruction for activating another program (“NO” in Step ST6), then processing returns to Step ST1.

If, in Step ST6, there has been an instruction to activate another program (“YES” in Step ST6), then the program launching portion 3 activates the applicable program, and displays the screen for the program that has been activated as the front-most screen (Step ST7).

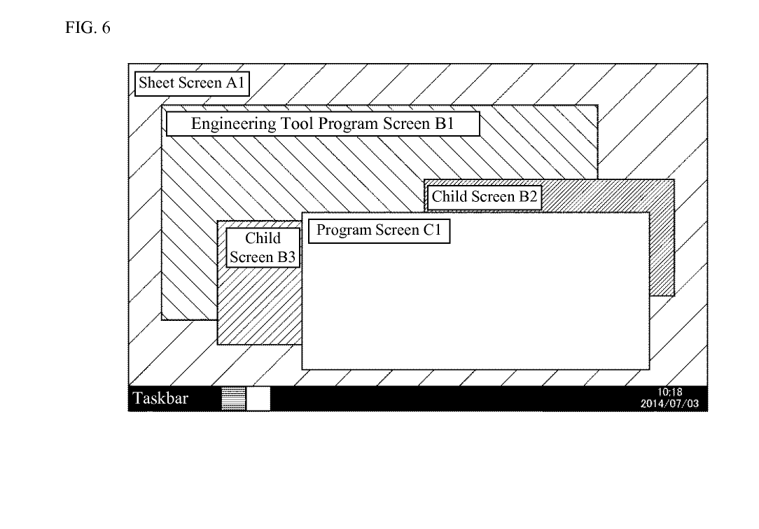

FIG. 6 is a diagram for explaining an example wherein a screen of a program other than the engineering tool is displayed, as instructed by a user, through a program launching portion 3.

When there is an instruction for activating the spreadsheet program C, from a screen such as explained in FIG. 4, in order to edit, using the spreadsheet program, the editing data in program group B, for example, the program launching portion 3 activates the spreadsheet program C, and the program screen C1 is displayed as the front-most screen, as illustrated in FIG. 6. Note that at this time the display sequence, from the front-most screen, as illustrated in FIG. 6, will be the program screen C1, the child screen B3, the child screen B2, the engineering tool program screen B1, and the sheet screen A1.

The user carries out the desired operations in the program screen C1 that is illustrated in FIG. 6.

When the user has performed the operations in the spreadsheet program C and completed the operations, then processing returns to the state of the screen that was explained in FIG. 4, and operations are continued.

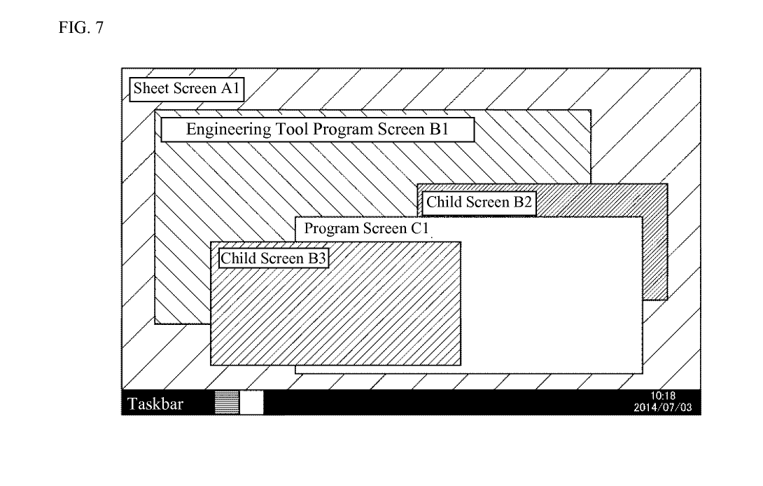

If here the user has completed the operations in the spreadsheet program C and wishes to return to operating the engineering tool B, then, in the normal Windows® operation, for example, it would be necessary to click the individual screens in the program group B to restore them to the displayed state. For example, in order to return from the state in FIG. 6 to the state of the screen explained in FIG. 4, the child screen B3 would be clicked first, to produce a state wherein the child screen B3 is displayed in the front, as illustrated in FIG. 7 (where the display sequence of the screens at this time, from the front-most screen, would be the child screen B3, the program screen C1, the child screen B2, the engineering tool program screen B1, and the sheet screen A1), and then, following this, it would be necessary to perform similar operations for the child screen B2, and the engineering tool program screen B1 as well.

However, in the engineering device according to this Example, it is possible to return to the state of the screen explained in FIG. 4, and to continue operations, through a single user instruction, where this operation will be explained following the flowchart in FIG. 2.

The screen switching portion 4 evaluates whether or not there has been a screen switching request from the user through the inputting portion (Step ST8). Specifically, the screen switching portion 4 evaluates whether or not any space (a region wherein a window is not displayed) within the sheet screen has been operated by the user through the inputting portion. In this Example, such an operation of the sheet screen (the back-most screen) by the user is defined as a “screen switching request.”

If, in Step ST8, there has been no screen switching request (“NO” in Step ST8), processing returns to Step ST1.

If, in Step ST8, there has been a screen switching request (“YES” in Step ST8), then the screen switching portion 4 carries out switching of the display by moving, to be the back-most screen, the screen for the program that was displayed as the front-most screen in Step ST7, to display, as the front-most screen, the screen for the program group of the engineering tool (Step ST9).

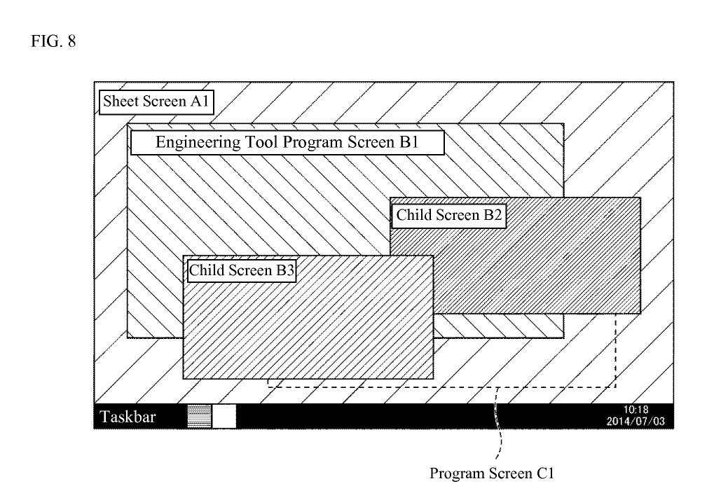

FIG. 8 is a diagram for explaining one example of a screen wherein display switching has been carried out through the screen switching portion 4.

When, from a screen as illustrated in FIG. 6, an arbitrary location of the sheet screen A1, which is the sheet screen, is, for example, clicked by the user using a mouse, then, as illustrated in FIG. 8, the screen switching program 4 displays the program screen C1 (the spreadsheet program) at the back-most screen, at a lower-level than the sheet screen A1.

In this way, the sheet screen A1 that relates to the program group B, and the engineering tool program screen B1, the child screen B2, and the child screen B3, that structure the program group B, are displayed at a higher-level than the program screen C1 (the spreadsheet program), while maintaining the display order thereof, through a single instruction by the user, thus making it possible to return to the engineering operations immediately. At this time, the program screen C1 is displayed behind the sheet screen A1, but because the sheet screen A1 that has a semi-transparent display, the user is able to check the display of the program screen C1 visually.

Note that the sheet screen A1 has the role of elevating to the front screen, while preserving the screen display order of the related program group B, but if, for example, the program group B is displayed on the entire screen display, then the sheet screen A1 will not be displayed (because there is no open area), and so the user will be unable to click an arbitrary location on the sheet screen A1.

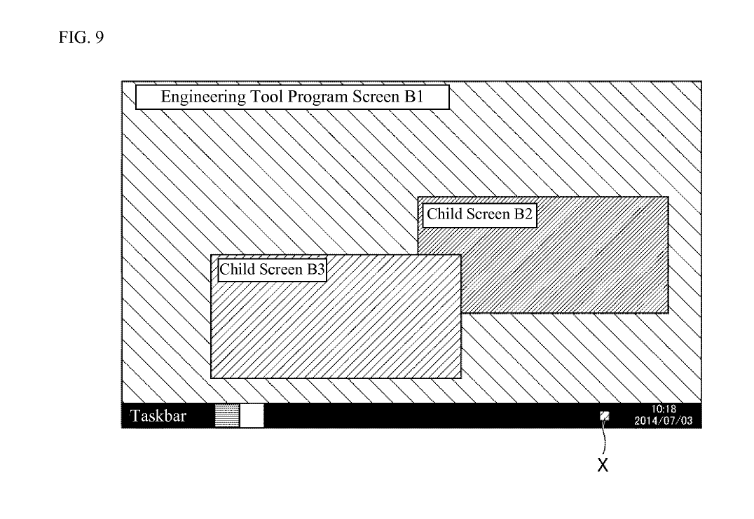

In this case, as illustrated in FIG. 9, the user can click an icon (indicated by the X in FIG. 9) for the sheet screen A1, stored in the task tray (a notification region) to execute a screen switching request, so that the screen switching portion 4 will carry out display switching by moving, to the back-most screen, the program screen C1 that was displayed as the front-most screen in Step ST7, so that the screen for the program group B of the engineering tool B will be displayed as the front-most screen.

While, in the explanation above, when there is a screen switching request the screen switching portion 4, as explained using FIG. 8, displays all of the screens related to the program, which structure the program group B, at a higher-level than C1 (the spreadsheet program), that is, as the front-most screen, there is no limitation thereto, but rather the screen switching portion 4 may display only an arbitrary screen designated by the user as the front-most screen.

Specifically, the engineering device is further provided with an operation selecting portion (not shown), where the operation selecting portion displays on the sheet screen A1 a list of the engineering program screen B1, the child screen B2, and the child screen B3 that structure the program group B, for example. Moreover, the operation selecting portion receives a selecting instruction for a screen specified by the user from among the engineering tool program screen B1, the child screen B2, and the child screen B3, where the screen switching portion 4 displays, as the screen that is subject to switching, the screen that has been received by the operation selecting portion, on a higher level than C1 (the spreadsheet program), that is, on the front-most screen.

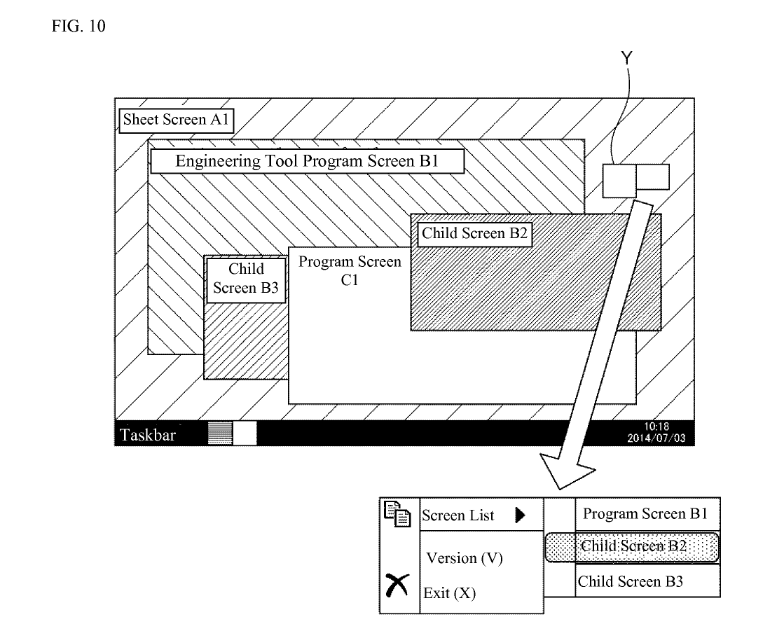

FIG. 10 is a diagram for explaining an example of a screen wherein display switching has been carried out so that a screen that has received an operation selecting portion is displayed as the front-most screen by the screen switching portion 4.

In FIG. 10, from a screen such as displayed in the FIG. 6, the operation selecting portion receives an instruction from the user wherein the child screen B2 of the screen list (indicated by the Y in FIG. 10) that is displayed on the sheet screen A1 has been selected, and the screen switching portion 4 causes only the child screen B2, which is the subject of switching, to be displayed at a higher level than C1 (the spreadsheet program), that is, as the front-most screen.

Doing this enables the user to carry out switching so as to display only the desired screen as the front-most screen, enabling operations to be performed more efficiently.

As described above, the Example enables an improvement in operational efficiency and a reduction in user time through enabling switching of a program group that is displayed and defined as a single group, through a single operation of the sheet screen (the back-most screen), when carrying out an operation when a plurality of window screens is displayed on the screen.

Note that while in this Example the engineering device is structured as illustrated in FIG. 1, there is no limitation thereto, but rather the engineering device may include a menu selecting portion 1, a program group display controlling portion 2, a program launching portion 3, a screen switching portion 4, and a screen display controlling portion 5.

Note that in the invention in the present application, arbitrary structural elements in the example may be modified, or arbitrary structural elements in the example may be omitted, within the scope of the invention.

1: An engineering device that defines control points for monitoring and controlling equipment that is installed in a building, and that defines parameters for carrying out control of instruments, comprising:
a menu selector selecting an operating menu from operating menu items of an engineering tool, prepared in advance;
a program group display controller displaying, on a display screen, screens relating to each of one or more programs, grouped in advance as a program group relating to the operating menu selected by the menu selector;
a program launcher activating a program other than the engineering tool and displaying, on the front-most screen of the display screen, a screen relating to the other program that has been activated;
a screen switch switching the display of the display screen so as to move, to the front-most screen of the display screen, screens relating to the individual programs that have been set as the program group, when there has been a screen switching request; and
a screen display controller adjusting the size or position of respective windows for a screen relating to the program group on the display screen in response to a display position adjusting instruction.

2: The engineering device as set forth in claim 1, further comprising:
an operation selector receiving a screen that is subject to switching, from among the screens related to the individual programs that are set as the program group, wherein:
the screen switch switches the display of the display screen so as to move, to the front-most screen of the display screen, the screen that is subject to switching, received by the operation selector.

3: A screen display controlling method using an engineering device that defines control points for monitoring and controlling equipment that is installed in a building, and that defines parameters for carrying out control of instruments, comprising:
a menu selecting step in which a menu selector selects an operating menu from operating menu items of an engineering tool, prepared in advance;
a program group display controlling step in which a program group display controller displays, on a display screen, screens relating to each of one or more programs, grouped in advance as a program group relating to the operating menu selected by the menu selector;
a program launching step in which a program launcher activates a program other than the engineering tool and displays, on the front-most screen of the display screen, a screen relating to the other program that has been activated;
a screen switching step in which a screen switch switches the display of the display screen so as to move, to the front-most screen of the display screen, screens relating to the individual programs that have been set as the program group, when there has been a screen switching request; and
a screen display controlling step in which a screen display controller adjusts the size or position of respective windows for a screen relating to the program group on the display screen in response to a display position adjusting instruction.
